(19) United States
(12) Patent Application Publication
(10) Pub. No.: US 2014/0075298 A1
(43) Pub. Date: Mar. 13, 2014

(54) DOCUMENT ANALYSIS AND PRESENTATION FOR USERS WITH SPECIAL NEEDS

(71) Applicants: MAUREEN ELIZABETH KRAFT, Hudson, MA (US); Michael A. Squillace, Austin, TX (US); Elizabeth Vera Woodward, Cedar Park, TX (US); Shunguo Yan, Austin, TX (US)

(72) Inventors: MAUREEN ELIZABETH KRAFT, Hudson, MA (US); Michael A. Squillace, Austin, TX (US); Elizabeth Vera Woodward, Cedar Park, TX (US); Shunguo Yan, Austin, TX (US)

(73) Assignee: International Business Machines Corporation, Armonk, NY (US)

(21) Appl. No.: 13/612,248

(22) Filed: Sep. 12, 2012

(51) Int. Cl. G06F 17/00

(52) U.S. Cl. 715/255

(57) ABSTRACT

A method, system, and computer program product for document analysis and presentation to a user, the user having a special need, are provided in the illustrative embodiments. A document is received for presentation to the user, the document including a plurality of parts, the plurality of parts including a preferred part, and wherein the user has to reach the preferred part in the document by sequentially processing a subset of parts preceding the preferred part in the document. The document is analyzed according to a set of attributes. The document is restructured to form a restructured document such that user can directly access the preferred part of the restructured document without having to sequentially process the restructured document. The restructured document is presented to the user having special needs.

### BACKGROUND

1. Technical Field:

The present invention relates generally to a method, system, and computer program product for presenting information to users with special needs. More particularly, the present invention relates to a method, system, and computer program product for document analysis and presentation for users with special needs.

2. Description of the Related Art:

A user with a disability or impairment is regarded as a user with special needs within this disclosure. Assistive technologies (ATs) are available for presenting information to users with different special needs. For example, some assistive technologies convert text to speech and “read” documents to visually impaired users. Some assistive technologies convert audio documents to text for users with auditory impairments. Additionally, some assistive technologies convert speech input to text or device commands for users with mobility impairments.

Information is presented differently to a user with special needs as compared to the presentation of the same information to another user without special needs. For example, technologies exist for presenting text in tactile form, such as using Braille, text in large fonts, images in high contrast, and sounds with adjusted volumes to users with various impairments or disabilities.

### SUMMARY

The illustrative embodiments provide a method, system, and computer program product for document analysis and presentation for users with special needs. In one embodiment, a method for document analysis and presentation to a user, the user having a special need receives a document for presentation to the user, the document including a plurality of parts, the plurality of parts including a preferred part, and wherein the user has to reach the preferred part in the document by sequentially processing a subset of parts preceding the preferred part in the document. The method analyzes the document according to a set of attributes. The method restructures the document to form a restructured document such that user can directly access the preferred part of the restructured document without having to sequentially process the restructured document. The method presents the restructured document to the user having special needs.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of an example document for analysis and presentation to a user with special needs in accordance with an illustrative embodiment;

FIG. 4 depicts a block diagram of an example configuration for document analysis and presentation for users with special needs in accordance with an illustrative embodiment; and

FIG. 5 depicts a flowchart of an example process of document analysis and presentation for users with special needs in accordance with an illustrative embodiment.

### DETAILED DESCRIPTION

The illustrative embodiments recognize that users without special needs process the information presented to them differently than users with special needs when presented with the same information in a different form. The illustrative embodiments recognize that merely presenting information in different forms to users with special needs is not effective for enabling similar use of the information by users with and without special needs.

For example, when taking online and electronic devices-based tests, such as via a learning management system, a sighted user is able to not only read the test data but also assess the test's structure, such as the number of questions or problems in the test; categories of questions or problems, for example, verbal, mathematical, or logical; types of questions, for example, multiple choice, fill-in-the-blank, or essay; complexity of questions; and the length of the test. The sighted user can scan and analyze any portion of the test data in any order for extracting such useful information about the test data.

In contrast, the illustrative embodiments recognize that to obtain a similar level of detail or information about the test data, a user with a visual impairment has to navigate the test serially using traditional assistive technologies, such as a screen reader, to extract this information. Thus, the illustrative embodiments recognize that a user with special needs is limited by the assistive technologies, which process the information serially and in specific pre-determined ways.

This limitation translates into a very time consuming exercise in processing the information being presented by assistive technologies, essentially putting users with special needs at a disadvantage compared to users without special needs. For example, when taking timed online and electronic devices-based tests, users with special needs often require extra time to complete the tests. A user without special needs can quickly scan the categories, numbers, types, complexities of the questions and answer choices to plan their progression through the test. The user without special needs can also go directly to a category or type of question, or even to a particular question they would like to answer, and plan the order in which they would like to take the test to best suit their needs and strengths.

The illustrative embodiments recognize that a user with special needs is dependent on the capabilities of assistive technologies, which presently do not provide this level or type of information about a document. For example, a test document may be formatted for a user accessing the text using a screen reader according to the categories and headings of questions to allow the screen reader user to easily navigate the sections of the test and individual questions. However, the screen reader still only performs “serial” progression through the test document, requiring the user with special needs to navigate through each and every question to get a sense of the questions or problems that are presented, and the categories or types into which they fall.

The IMS Question and Test Interoperability specifications (QTI) define a standard for formatting of test or assessment content and results. The QTI standard specifies numerous question attributes, including question type—e.g., multiple choice, essay, fill-in-the-blank, or matching, question text, correct and incorrect responses, media to be available as part of the question—e.g., video, images, or audio, and feedback in response to user's selection of answers. QTI also includes specification of a test/assessment that can include numerous items and collections of items into sets, time restrictions, and maximum attempts. The illustrative embodiments recognize that specifications such as QTI do not include an overarching description of the test, such as the number of test items/questions of each question type, an analysis of which question statements are longer or more complex, which multiple choice questions have longer answers (entailing each takes longer to analyze), and other summary or analysis that would enable a user with special needs to take the test in a way that aligns with their preferences without having to sequentially review the entire test.

Additional standards, such as Sharable Content Object Reference Model (SCORM), define the sequence in which a learner can experience objects, including assessment objects, and permit the user to define bookmarks in their learning module. With SCORM, more complex adaptive sequencing can be based on complex computation of user preferences or assessment results. However, the illustrative embodiments recognize that even standards such as SCORM do not provide a user with special needs an overview and analysis of the test that will help them to make decisions and order their taking of the assessment in a way that meets with their preferences.

SCORM metadata is recorded in a well-defined format known as “learning object metadata”, or “LOM”. LOM contains many predefined fields for describing learning content, including pedagogical characteristics, interactively type (for example, questionnaire), interactively level, semantic density, and difficulty level in the order of very easy to very difficult. However, the illustrative embodiments recognize that this information is insufficient to provide the amount or quality of information to guide a user in making decisions regarding the sequence in which they would prefer to take the test.

Thus, the presently available assistive technologies fail to provide guidance to the user with special needs regarding the format, organization, and structure of a document. Presently available assistive technologies also fail to enable users with special needs to act upon their preferences in sequencing their actions on the document into their preferred order

The illustrative embodiments used to describe the invention generally address and solve the above-described problems and other problems related to providing information about a document to a user with special needs. The illustrative embodiments provide a method, system, and computer program product for document analysis and presentation for users with special needs.

The illustrative embodiments describe a system and method to provide additional information for users of assistive technologies. Using an embodiment, a user with special needs is able to analyze and structure interactions with documents in a manner mirroring users without special needs. In an embodiment, the additional information includes, but is not limited to, summary and analysis of the structure of documents such as test questionnaires. For example, the embodiment provides a user with special needs additional information about question text, types of questions, acceptable responses, and other complexity factors that can influence the order and approach the user would use to select the sequence in which they would complete the test.

An embodiment further provides a way to export the summary and significant semantic information about a document to existing assistive technologies. For example, an implementation of an embodiment can integrate with or modify an existing assistive technology, such as a screen reader, to continue to provide presently available accessibility features together with the flexibility of analyzing the presented document and organizing their interactions therewith.

The illustrative embodiments are described with respect to certain applications only as examples. Such descriptions are not intended to be limiting on the invention. For example, an illustrative embodiment described with respect to a screen reader can be implemented with respect to another assistive technology providing a different accessibility feature without limitation.

The illustrative embodiments are described with respect to certain data only as examples. Such descriptions are not intended to be limiting on the invention. For example, an illustrative embodiment described with respect to a test questionnaire document can be implemented with respect to any other type of document containing any type of data, such as text, audio, and video, within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, layouts, schematics, and tools only as examples and are not limiting on the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting on the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

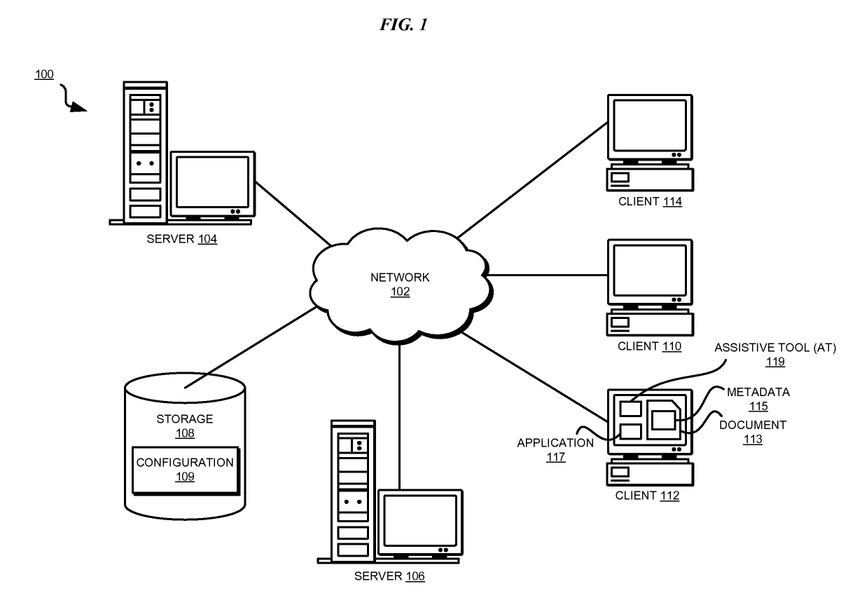

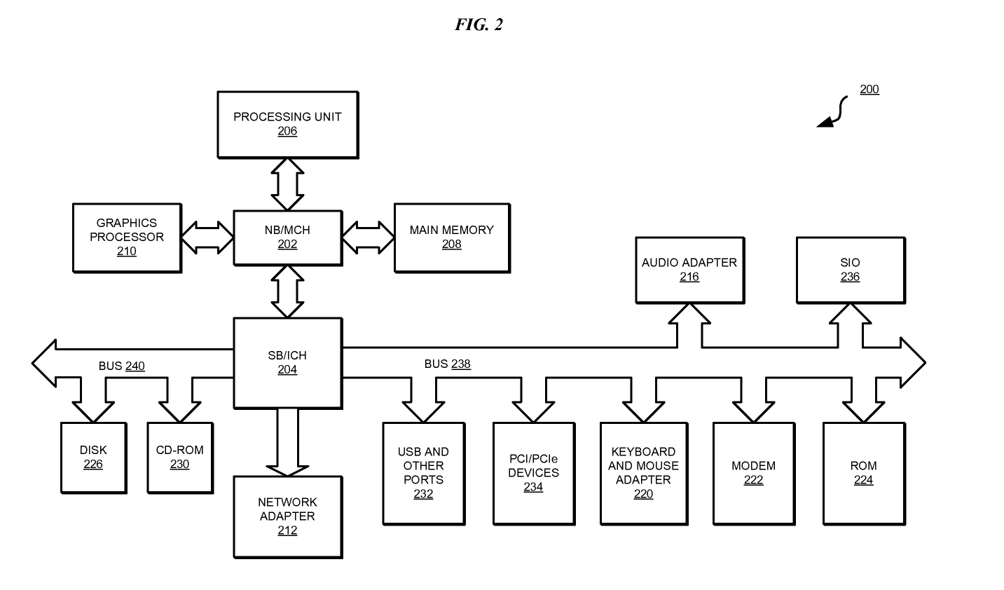

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of data processing systems in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any data processing system or device in data processing environment 100.

Clients 110, 112, and 114 also couple to network 102. A data processing system, such as server 104 or 106, or client 110, 112, or 114 may contain data and may have software applications or software tools executing thereon.

Only as an example, and without implying any limitation to such architecture, FIG. 1 depicts certain components that are used for document analysis and presentation for users with special needs according to an embodiment. For example, client 112 may be a data processing system or device, not necessarily a computer, that is usable for presenting a document to a user with special needs. In the depicted example configuration, client 112 includes assistive tool 119. Document 113 is a document that is to be presented to the user with special needs. According to an embodiment, document 113 is modified to include metadata 115 to facilitate the analysis and presentation of document 113. Application 117 implements an embodiment, and uses metadata 115 and configuration 109 to operate in conjunction with assistive tool 119 for performing document analysis and presentation for users with special needs. Configuration 109 according to an embodiment can be stored anywhere in a data processing environment without any limitation, including but not limited to storage 108.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

Servers 104 and 106, storage unit 108, and clients 110, 112, and 114 may couple to network 102 using wired connections, wireless communication protocols, or other suitable data connectivity. For example, a cluster typically has multiple network types, such as IP networks, direct connections of machines via packets exchange implemented by storage protocols (Fibre Channel, SCSI), serial links, and message exchange via writing and reading packets to shared storage such as a hard disk drive. For performance reasons, in sending client traffic, an IP network is given precedence. Furthermore, a given network type may not connect to all nodes in a cluster. For instance, a cluster may span machines located at two geographically distant sites. For the long distance connection, Ethernet may be the preferred connection, and within a geographical location, a direct connection may be preferable. Additionally, within a geographical location, additional non-IP networks, such as Fibre channel or serial connections may be used within the scope of the illustrative embodiments.

Clients 110, 112, and 114 may be, for example, personal computers, network computers, thin clients, mobile devices, phones, smartphones, tablet computing devices, or industrial control systems. In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another, and encompasses components including but not limited to IP and SAN components. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), a wide area network (WAN), or mobile ad hoc network (MANET). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104, server 106, or client 112 in FIG. 1, or another type of device in which computer usable program code or instructions implementing the processes of the illustrative embodiments may be located for the illustrative embodiments. Data processing system 200 is also representative of a computing device, such as a device used to implement an assistive technology to assist a user with special needs (not shown), in which computer usable program code or instructions implementing the processes of the illustrative embodiments may be located for the illustrative embodiments. Data processing system 200 is described as a computer only as an example, without being limited thereto.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may include one or more processors and may be implemented using one or more heterogeneous processor systems. Graphics processor 210 may be coupled to NB/MCH 202 through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCl/PCIe devices 234 are coupled to south bridge and I/O controller hub 204 through bus 238. Hard disk drive (HDD) 226 and CD-ROM 230 are coupled to south bridge and I/O controller hub 204 through bus 240. PCl/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204 through bus 238.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States, other countries, or both), or Linux® (Linux is a trademark of Linus Torvalds in the United States, other countries, or both). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Program instructions for the operating system, the object-oriented programming system, the processes of the illustrative embodiments, and applications or programs, including application 117, are located on one or more storage devices, such as hard disk drive 226 or CD-ROM 230, and may be loaded into at least one of one or more memories, such as main memory 208, read only memory 224, or one or more peripheral devices, for execution by processing unit 206. Program instructions may also be stored permanently in non-volatile memory and either loaded from there or executed in place. For example, the synthesized program according to an embodiment can be stored in non-volatile memory and loaded from there into DRAM.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

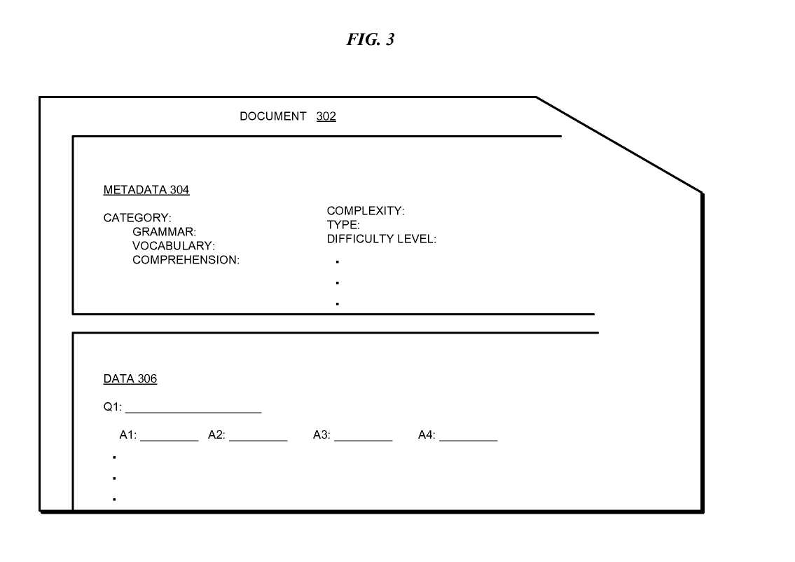

With reference to FIG. 3, this figure depicts a block diagram of an example document for analysis and presentation to a user with special needs in accordance with an illustrative embodiment. Document 302 is similar to document 113 in FIG. 1.

A system or a user (collectively, “author”) produces document 302. In accordance with an embodiment, document 302 includes metadata 304, which describes certain aspects of document 302, or a part thereof, such as data 306. Document 302 may include several instances of metadata 304 and several instances of data 306. Metadata 304 is used by an embodiment to analyze and present all or part of document 302, such as data 306 or a variation thereof, to a user with special needs.

Only as an example, and without implying any limitations thereto, metadata 304 is depicted to include several example attributes towards this purpose. Those of ordinary skill in the art will be able to create other sets of attributes to include in metadata 304 that are more suitable for the particular document portion being presented, assistive tool being used, or the user being targeted.

In one embodiment, metadata 304 is implicit in the manner of depicting data 306. For example, data 306 could be made available in document 302 in a tree structure where a category or a type of sub-data, such as a category of questions in a test, is represented as a root node in the tree and individual sub-data, such as the questions, as leaves. Furthermore, metadata 304 may not be embedded or included in document 302 but received from another application or system separately. The embodiments described herein are described with respect to metadata being included in a document, such as metadata 304 in document 302, only for the clarity of the description and not as a limitation on the illustrative embodiments.

For the depicted example, assume that data 306 portion of document 302 were a test questionnaire. Accordingly, an author of document 302 includes attributes in metadata 304 that describe data 306 by category, such as whether the section tests grammar, vocabulary, or comprehension in an English language test.

Another attribute describes a type of a portion of document 302, such as whether the test or part thereof includes multiple choice questions, fill in the blank questions, true or false choice questions, or questions requiring essay answers. Another attribute describes a type of a portion of document 302, such as the difficulty level of the portion as introductory level, intermediate level, or advanced level.

The depicted attributes are only examples and are not intended to represent an exhaustive list of attributes for any type of document 302 or data 306. Metadata 304 can include an attribute in accordance with an existing standard, a proprietary attribute, a non-standard attribute specific to document 302 or data 306, an attribute specific to an author of document 302 or data 306, an attribute specific to an assistive tool or technology to be used with document 302 or data 306, an attribute specific to a target user, or a combination thereof.

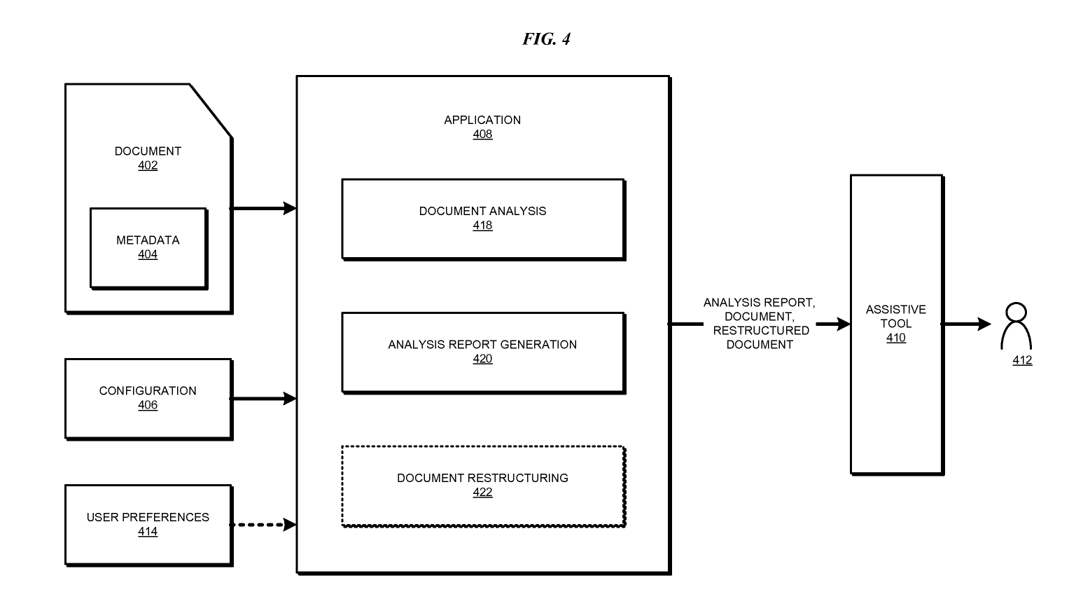

With reference to FIG. 4, this figure depicts a block diagram of an example configuration for document analysis and presentation for users with special needs in accordance with an illustrative embodiment. Document 402 and metadata 404 are similar to document 302 and metadata 304 in FIG. 3, respectively. Configuration 406 is similar to configuration 109 in FIG. 1. Application 408 is similar to application 117 in FIG. 1. Assistive tool 410 is similar to assistive tool 119 in FIG. 1. User 412 is a user with special needs.

While author-supplied metadata 404 can describe document 402 or a part thereof, many other factors play a part in the analysis of document 402 for presentation to user 412. Configuration 406 includes a set of attributes that describe a how, why, or when a document, such as document 402, has to be analyzed for presentation to user 412. The attributes in configuration 406 can be organized in any suitable manner. For example, an image can be analyzed in many different ways depending on how the image is going to be used, why the image is being analyzed, and when in a workflow, the image is being analyzed.

For example, an image of a machine and people in an environment can be analyzed in different ways for different purposes. When user 412 is an engineer working on machines, analyzing the features of machine in the image is more relevant to user 412. When user 412 is has a security function, analyzing the environment in which the people and the machine are present is more relevant to user 412. When user 412 happens upon the image while searching for clip art, the people, the machine, and the environment aspects should be analyzed relative to another similar picture at another location. In other words, attributes in configuration 406 can describe a context of analysis of document 402, a domain whose knowledge is relevant in the analysis, and circumstances in which the analysis has to be performed.

Furthermore, configuration 406 can include attributes specific to document 402, which are not available in metadata 404, or should have values different from corresponding attributes in metadata 404 (override attributes). For example, assume that document 402 includes a test questionnaire portion that is described using metadata 404. Specifically, assume that metadata 404 includes a “difficulty” attribute that takes one or three values to indicate three corresponding levels of difficulty. When the test is administered to specific user 412, the test administrator may wish to indicate the difficulty on a four level scale. Configuration 406 can include a difficulty attribute that takes one of four values to indicate the corresponding four difficult levels, and override the difficulty attribute in metadata 404.

An attribute in configuration 406 may be specific to assistive tool 410. For example, if the difficulty attribute in metadata uses numeric values. However, assistive tool 410 must inform user 412 using audible tones. An override attribute in configuration 406 can replace the numeric values from metadata 404 with tonal codes.

An attribute in configuration 406 can also be policy based. For example, metadata 404 may describe a category of information using a proprietary term, such as a brand name or a product name. A policy of an environment, such as an employer of user 412, may require proprietary terms replaced with non-specific industry terms. Accordingly, an attribute in configuration 406 may override all or some category name values specified in metadata 404.

User-specific attributes can be specified in configuration 406, user preferences 414, or both. For example, in one case, configuration 406 may not be under the control of user 412. In such a case, user-specific attributes may be specified in user preferences 414. In another case, configuration 406 may be generally applicable to several documents but user 412 may wish to analyze one particular document differently. In such a case, user 412 can specify attributes for the one-off analysis in user preferences 414 without disturbing the attributes in configuration 406.

For example, 412 may be a student taking a test using document 402. User 412 may want to analyze document 402 or parts thereof in a manner not specified in metadata 404 or configuration 406. An attribute in user preferences 414 may specify that document 402 should be analyzed first to search for questions that pertain to a certain topic of study, such as including certain keywords. Once those questions are identified, perhaps as questions that user 412 will answer first, document 402 should be analyzed next for questions that require true/false answers but are no more than twenty words in length. Following that step of analysis, document 402 should be analyzed for true/false questions that are longer than twenty words but are multipart questions. As can be seen, user 412 can specify attributes in user preferences 414, configuration 406, or both, to customize the analysis of document 402 beyond the possibilities from author-specified metadata attributes, or standard environment configuration attributes.

The example types of documents, attributes, values of the attributes, and locations or purposes of the attributes described herein are not intended to be limiting on the illustrative embodiments. Those of ordinary skill in the art will be able to conceive many different attributes, values, document types, and purposes for analysis applicable to various types of documents and users from this disclosure and the same are contemplated within the scope of the illustrative embodiments.

Application 408 receives document 402, metadata 404, and configuration 406. If user preferences 414 are available and applicable to document 402, application 408 receives user preferences 414 as well. Application 408 includes component 418 for performing document analysis according to metadata 404, configuration 406, and user preferences 414.

For example, assume that at least a portion of document 402 includes a test questionnaire. Using a combination of attributes in metadata 404, configuration 406, and user preferences 414, application 408 analyzes the test items in document 402. For example, application 408 identifies a length of certain text, semantic density, length of multiple choice responses, number of questions in each category type, significant words or phrases, number of questions that are delivered in various modalities such as text, audio, video, or image, and other criteria that might influence user 412′s preferences for reorganizing document 402 and taking the test therein.

Analysis report generation component 420 summarizes the results of the analysis performed by component 408. An example report generated from component 420 for a test questionnaire in document 402 delineates the categories in the test, difficult levels associated with the test items for a given test suit, and summarizes the structure, sequence and format information for the test suit.

Document restructuring component 422 restructures, re-organizes, re-formats, re-arranges, or otherwise manipulates document 402 or a part thereof according to the analysis results and attributes of configuration 406 and user preferences 414. Application 408 then makes the analysis report, the original form of document 402 or part thereof, the restructured form of document 402 or part thereof, or a combination thereof, to assistive tool 410. Assistive tool 410 presents the manipulated form of all or part of document 402 to user 412.

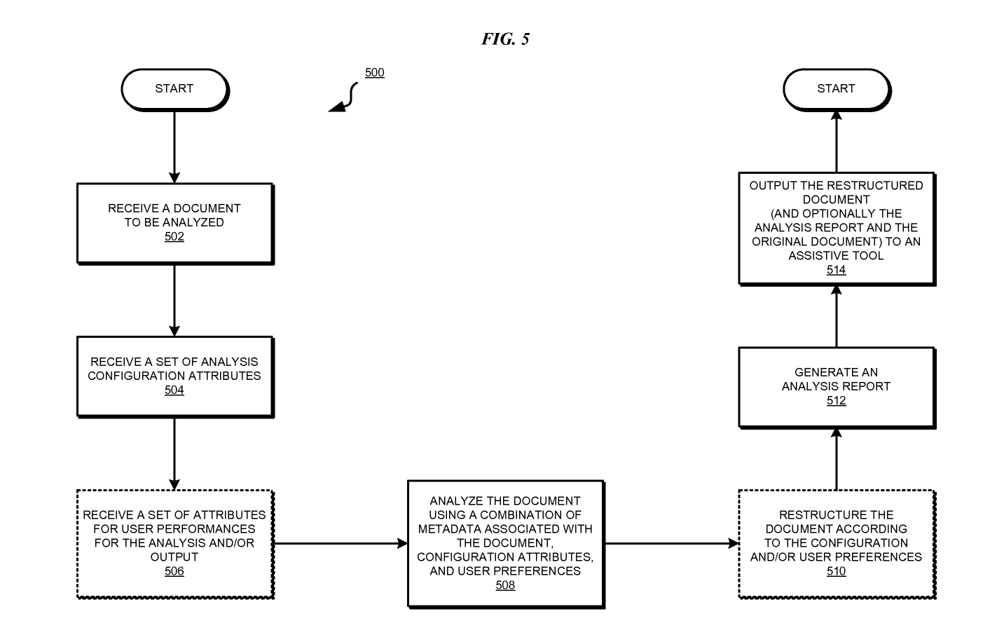

With reference to FIG. 5, this figure depicts a flowchart of an example process of document analysis and presentation for users with special needs in accordance with an illustrative embodiment. Process 500 can be implemented in application 408 in FIG. 4.

Process 500 begins by receiving a document to be analyzed (step 502). Process 500 receives a set of configuration attributes for analyzing the document (step 504). Either as a part of the configuration attributes of step 504, or separately, process 500 receives a set of attributes representing user preferences for the analysis of an output to be generated from the analysis (step 506). In one embodiment, receiving user preferences at step 506 may be optional.

Process 500 analyzes the document using a combination of metadata associated with the document, configuration attributes, and user preferences (step 508). Process 500 restructures the document according to the configuration and/or user preferences (step 510). For example, in one embodiment, as a part of the restructuring of step 510, process 500 may rearrange the questions such that the rearranged order of the questions reflects a user's preferred order of answering them instead of the order in which the questions appear in a test document.

In another embodiment the restructuring of step 510 may present different parts of the document of step 502 differently from the presentation of those parts in the document of step 502. The difference in the presentation can be, for example, by using different colors, sounds, sizes, tactile stimulations, translations, or speeds of presentation. One question may appear in a color and/or font size different from another; more complex questions may be presented slower than relatively easier questions; words or phrases may be translated to synonymous forms or to a different language, such as sign language; and many other variations of presentations without being limited to the examples described herein.

Process 500 also generates an analysis report (step 512). In one embodiment, the analysis report may be for use within an application implementing an embodiment, such as within application 408 in FIG. 4 for performing the restructuring operation in component 422 in FIG. 4. In another embodiment, the analysis report may be exported to an assistive tool for presentation to the user, use within the assistive tool, or both.

Process 500 outputs the restructured document, and optionally the analysis report and the original document of step 502 to an assistive tool, such as assistive tool 410 in FIG. 4 (step 512). Process 500 ends thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for document analysis and presentation for users with special needs. Given a document, an embodiment exposes a form or assessment structure, formatting, sequencing and content information related to the document to assistive technologies. Such exposure allows assistive technologies to aid users with special needs in managing their interactions with the document, or a version thereof, in a manner comparable to users without special needs. Using the information provided by an embodiment in combination with the document, a user with special needs can avoid the sequentially review of the document and arrange parts of the document in a manner most conducive to the user's abilities and preferences.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A computer implemented method for document analysis and presentation to a user, the user having a special need, the computer implemented method comprising:
receiving a document for presentation to the user, the document including a plurality of parts, the plurality of parts including a preferred part, and wherein the user has to reach the preferred part in the document by sequentially processing a subset of parts preceding the preferred part in the document;
analyzing the document according to a set of attributes;
restructuring the document to form a restructured document such that user can directly access the preferred part of the restructured document without having to sequentially process the restructured document; and
presenting the restructured document to the user having special needs.

2. The computer implemented method of claim 1, wherein the presenting comprises:
sending the restructured document to an application that presents the restructured document to the user with special needs via an accessibility enhancement.

3. The computer implemented method of claim 1, wherein the set of attributes is specified in a configuration for the analyzing.

4. The computer implemented method of claim 1, wherein the set of attributes includes a subset of attributes representing preferences of the user, the preferences indicating a manner in which the user wishes to have the plurality of parts presented to the user.

5. The computer implemented method of claim 1, further comprising:
generating an analysis report, the analysis report including information usable for the restructuring.

6. The computer implemented method of claim 1, wherein the restructuring further uses a metadata associated with the document.

7. The computer implemented method of claim 1, wherein the document is a questionnaire for a test and the parts are questions in the test.

8. A computer usable program product comprising a computer usable storage medium including computer usable code for document analysis and presentation to a user, the user having a special need, the computer usable code comprising:
computer usable code for receiving a document for presentation to the user, the document including a plurality of parts, the plurality of parts including a preferred part, and wherein the user has to reach the preferred part in the document by sequentially processing a subset of parts preceding the preferred part in the document;
computer usable code for analyzing the document according to a set of attributes;
computer usable code for restructuring the document to form a restructured document such that user can directly access the preferred part of the restructured document without having to sequentially process the restructured document; and
computer usable code for presenting the restructured document to the user having special needs.

9. The computer usable program product of claim 8, wherein the presenting comprises:
computer usable code for sending the restructured document to an application that presents the restructured document to the user with special needs via an accessibility enhancement.

10. The computer usable program product of claim 8, wherein the set of attributes is specified in a configuration for the analyzing.

11. The computer usable program product of claim 8, wherein the set of attributes includes a subset of attributes representing preferences of the user, the preferences indicating a manner in which the user wishes to have the plurality of parts presented to the user.

12. The computer usable program product of claim 8, further comprising:
computer usable code for generating an analysis report, the analysis report including information usable for the restructuring.

13. The computer usable program product of claim 8, wherein the restructuring further uses a metadata associated with the document.

14. The computer usable program product of claim 8, wherein the document is a questionnaire for a test and the parts are questions in the test.

15. The computer usable program product of claim 8, wherein the computer usable code is stored in a computer readable storage medium in a data processing system, and wherein the computer usable code is transferred over a network from a remote data processing system.

16. The computer usable program product of claim 8, wherein the computer usable code is stored in a computer readable storage medium in a server data processing system, and wherein the computer usable code is downloaded over a network to a remote data processing system for use in a computer readable storage medium associated with the remote data processing system.

17. A data processing system for document analysis and presentation to a user, the user having a special need, the data processing system comprising:
a storage device including a storage medium, wherein the storage device stores computer usable program code; and
a processor, wherein the processor executes the computer usable program code, and wherein the computer usable program code comprises:
computer usable code for receiving a document for presentation to the user, the document including a plurality of parts, the plurality of parts including a preferred part, and wherein the user has to reach the preferred part in the document by sequentially processing a subset of parts preceding the preferred part in the document;
computer usable code for analyzing the document according to a set of attributes;
computer usable code for restructuring the document to form a restructured document such that user can directly access the preferred part of the restructured document without having to sequentially process the restructured document; and
computer usable code for presenting the restructured document to the user having special needs.

18. The data processing system of claim 17, wherein the presenting comprises:
computer usable code for sending the restructured document to an application that presents the restructured document to the user with special needs via an accessibility enhancement.

19. The data processing system of claim 17, wherein the set of attributes is specified in a configuration for the analyzing.

20. The data processing system of claim 17, wherein the set of attributes includes a subset of attributes representing preferences of the user, the preferences indicating a manner in which the user wishes to have the plurality of parts presented to the user.
